(19) United States
(12) Patent Application Publication
(10) Pub. No.: US 2005/0173218 A1
(43) Pub. Date: Aug. 11, 2005

(54) Crank with freewheel

(76) Inventors: Manfred Walther, Bolligen (CH); Urs Tanner, Worb (CH)

Correspondence Address: Baniak Pine & Gannon, 150 N Wacker Drive, Suite 1200, Chicago, IL, 60606, US

(21) Appl. No.: 10/514,803

(22) PCT Filed: May 30, 2003
(86) PCT No.: PCT/CH03/00340

(30) Foreign Application Priority Data
Jun. 3, 2002 (CH) 0926/02
Nov. 29, 2002 (CH) 2017/02

(51) Int. Cl. F16D 41/24

(52) U.S. Cl. 192/64

(57) ABSTRACT

A crank has a crank arm (3) and a freewheel element (1, 2) for fastening the crank arm (3) on a crankshaft. When the crank arm (3) is rotated in a first direction, a torque is transmitted to the crankshaft. When the crank arm (3) is rotated in a second, opposite direction, the crank arm (3) rotates in freewheeling mode. The crank furthermore has at least one fixing means (6, 6′) for cancelling freewheeling, allowing the torque of the crank arm (3) to be transmitted to the crankshaft in both directions of rotation. This crank allows simple switching between one-way coupling and two-way coupling and significantly increases the available training and therapy options.

### TECHNICAL FIELD

The invention relates to a crank in accordance with the precharacterizing clause of Claim 1. This crank is preferably suitable for cycles, mountain bikes, home trainers, training equipment and medical exercise equipment.

### PRIOR ART

A pedal crank of the generic type for a cycle or a piece of training equipment is known from U.S. Pat No. 5,860,329. It has a crank arm for a pedal and a freewheel clutch for connection to a crankshaft of a cycle. This freewheel clutch essentially comprises a freewheel or one-way sleeve, which is connected in a rotationally fixed manner to the crank arm, and an adapter, which can be connected in a rotationally fixed manner to the crankshaft. The freewheel clutch makes it possible for a torque to be transmitted to the crankshaft and hence to a cycle chain when the crank is turned in a first direction. However, rotation in the opposite direction takes place in freewheeling mode, i.e. the torque is not transmitted.

In the case of this one-way pedal crank, the pedals of a cycle turn independently of one another. Each pedal must therefore be moved actively upwards. Unless at least the weight of the pedal is used for this purpose, the two pedals no longer turn synchronously. The rider will automatically increase the effort expended in order to pedal “smoothly” again, i.e. to operate the two pedals in the same rhythm, though with a phase shift. This one-way pedal crank furthermore allows the rider to produce a relatively constant and high power output over a relatively long period of time. In the case of training equipment, all the leg muscles, especially the muscles at the back of the leg, can be exercised in this way.

### DESCRIPTION OF THE INVENTION

It is an object of the invention to improve the pedal crank of the type stated at the outset in such a way as to provide more training options.

This object is achieved by a crank having the features of Patent Claim 1.

The crank according to the invention has at least one fixing means to enable either freewheeling dependent on the direction of rotation or torque coupling in both directions of rotation.

This fixable freewheel pedal crank has a number of advantages. Thus a rider who is not experienced with the freewheel system can switch back at any time to the system with which he is familiar. This ensures that he does not overexert untrained muscles, e.g. the muscles at the back of the leg, when training.

With the purchase of this device, the purchaser obtains not only the system already familiar to him but also a new system, which he can use and test as desired. There are no separate acquisition costs for this new, as yet unfamiliar system.

However, the crank according to the invention is also suitable for medical exercise equipment, especially in rehabilitation. The ability to switch the torque transmission systems over makes it possible to explain sequences of motion to the patient more effectively. His coordination abilities are improved or, in the area of therapy, restored.

In particular, the crank according to the invention can be used as a pedal crank in cycles and similarly constructed means of locomotion and in training or exercise equipment. However, the area of application is not restricted to this. It can also be used, for instance, in manually driven equipment in which switching between an enforced phase-shifted or in-phase synchronous motion and freewheeling is desired.

Further advantageous embodiments will emerge from the dependent claims.

### BRIEF DESCRIPTION OF THE DRAWING

The subject matter of the invention will be explained below with reference to preferred exemplary embodiments, which are illustrated in the attached drawing, in which:

FIG. 1 shows a partial section through a crank according to the invention in a first embodiment;

FIG. 2 shows a cross section through the crank in FIG. 1 along A-A;

FIG. 3 shows a partial section through a crank according to the invention in a second embodiment;

FIG. 4 shows a cross section through the crank in FIG. 3 along A-A;

FIG. 5 shows a cross section through the crank in FIG. 3 along B-B;

FIG. 6 shows a partial section through a crank according to the invention in a third embodiment;

FIG. 7 shows a cross section through the crank in FIG. 6 along A-A;

FIG. 8 shows a cross section through a crank according to the invention in a fourth embodiment;

FIG. 9 shows a partial section through the crank in FIG. 8;

FIG. 10 shows a side view of a locking stud in FIG. 8;

FIG. 11 shows a cross section along A-A in FIG. 10;

FIG. 12 shows a cross section along B-B in FIG. 10;

FIG. 13 shows a cross section through a crank according to the invention in a fifth embodiment, and

FIG. 14 shows a partial section through the crank in FIG. 13.

### WAYS OF IMPLEMENTING THE INVENTION

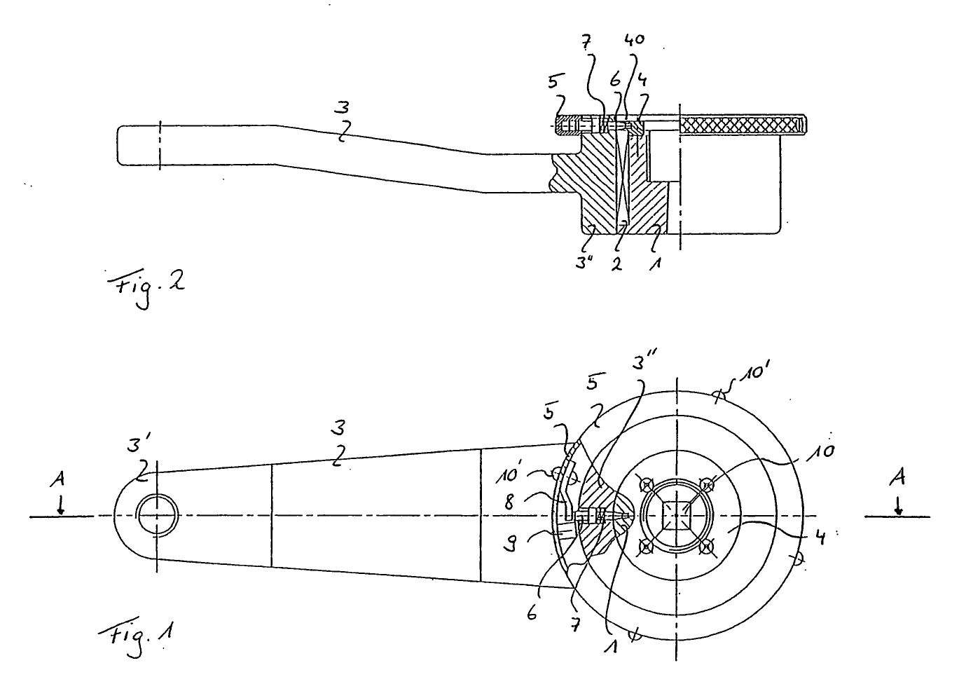

FIGS. 1 and 2 illustrate a first exemplary embodiment of the crank according to the invention. It has an adapter 1, which has a receiving opening 10 for a crankshaft of a cycle or some other device. The receiving opening 10 is used for the rotationally fixed connection of the adapter 1 to the crankshaft and therefore generally has a square/octalink cross section. The adapter has a cylindrical main body, which is preferably provided with a flange on the crankshaft side. A one-way or freewheel sleeve 2 is mounted on the adapter 1. This sleeve is connected in a rotationally fixed manner to a crank arm 3. For this purpose, the crank arm 3 has at one end a cylindrical housing 3″, in which the freewheel sleeve 2 is arranged. If the crank is used as a pedal crank, the crank arm 3 can be connected at the other end to a pedal (not shown here). The housing 3″, the freewheel sleeve 2 and the adapter 1 are preferably connected to one another and in relation to the crankshaft by means of screwed joints. The adapter 1 and the freewheel sleeve 2 form a one-way freewheel coupling. That is to say, a rotation of the crank arm 3 in a first direction of rotation transmits a torque to the crankshaft and thus to a cycle chain or some other drive element. In the case of rotation in the opposite direction, the crank arm 3 runs free. The torque produced is decoupled from the adapter 1 and hence from the crankshaft. As mentioned at the outset, a synchronously phase-shifted motion of the two pedals is only possible if the rider exerts on each individual pedal a force which is uniform over time. Moreover, thanks to this clutch the pedals can also rotate in phase, increasing the available training and therapy options.

One-way couplings of this kind are known from the prior art. In this connection, attention is drawn to U.S. Pat. No. 5,860,329, mentioned at the outset. However, the construction of the one-way coupling should not be limited to this embodiment.

According to the invention, there is at least one fixing means, which allows optional switching from this one-way coupling to a two-way coupling, with the torque thus being transmitted to the crankshaft in both directions of rotation. In the example illustrated here, this fixing means is a sprung locking stud 6, which passes through a through opening in the housing 3″ and which can be brought into engagement with a receiving opening 40 of a cover disc 4. The cover disc 4 is arranged in a rotationally fixed manner on the adapter 1 or some other element connected in a rotationally fixed manner to the crankshaft.

In the example illustrated here, the locking stud 6 is actuated by means of a turning ring 5. The turning ring 5 is arranged concentrically around the cover disc 4 and in such a way as to be rotatable relative to the latter. There is an encircling cavity between the housing 3″ and the turning ring 5. As can be seen in FIG. 1, a spring strap 8 arranged on the inner ring surface of the turning ring 5 projects into this cavity. The spring strap 8 is preferably fastened to the turning ring 5 by means of a rivet 10′. By turning the turning ring 5, in this case in the clockwise direction, the locking stud 6 held in the housing 3″ is pushed in the direction of the receiving opening 40 of the cover disc 4 against the spring force of a return spring 7, with the result that it forms a form-locking connection between the crank arm 3 and the crankshaft. To prevent the turning ring 5 from being turned too far, it preferably has a stop stud 9, which projects into the cavity at a location adjacent to the spring strap 8 and rests against the locking stud 6 in the locked state. The locking stud 6 acts as a driver for the cover disc 4, with the result that the torque is transmitted from the crank arm 3 to the crankshaft even when the freewheel sleeve 2 is freewheeling. If the turning ring 5 is turned in the other direction, the locking stud 6 slides outwards along the spring strap 8 and releases the cover disc 4 again. In this state, torque transmission then takes place only in one direction of rotation.

A plurality of fixing means is preferably provided. It is advantageous if they are arranged as uniformly as possible around the periphery. In the example illustrated here, there are four locking studs 6 and four associated spring straps 8. However, it is also possible to use three or some other number of studs.

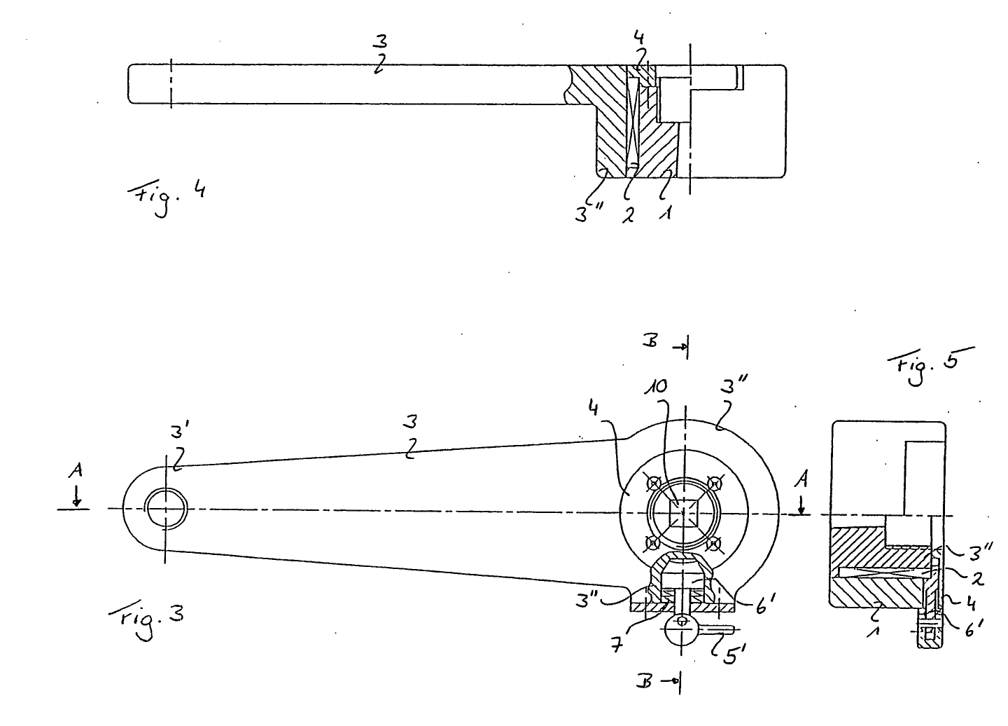

A second preferred exemplary embodiment is illustrated in FIGS. 3 to 5. The one-way coupling is of identical construction to the first exemplary embodiment and is therefore not described further. Identical parts are denoted by the same reference numerals as in FIGS. 1 and 2.

As the fixing means, however, there is now a locking wedge 6′, which can be actuated by means of an eccentric stud 5′. If the eccentric stud 5′ is turned in one direction, in this case in the clockwise direction, the locking wedge 6′ turns into the receiving opening 40 of the cover disc 4 and again forms a driver for the adapter 1 or some other suitable element. If the eccentric stud 5′ is turned in the opposite direction, the cover disc 4 is released.

The two embodiments described above have the advantage that the means for switching between the two systems are relatively small. Moreover, the fixing means can also be operated by an experienced rider or, in the case of a rehabilitation exercise, by the therapist. Another advantage is the fact that existing one-way couplings can also be retrofitted with the switch according to the invention. For this purpose, all that is required is for a cover disc to be connected to the existing crank and for the crank arm to be replaced by a new crank arm with a turning ring and an integrated fixing means. If a disc-shaped intermediate element is fastened in a rotationally fixed manner to the crank-arm housing, which has the fixing means, the crank arm does not have to be replaced.

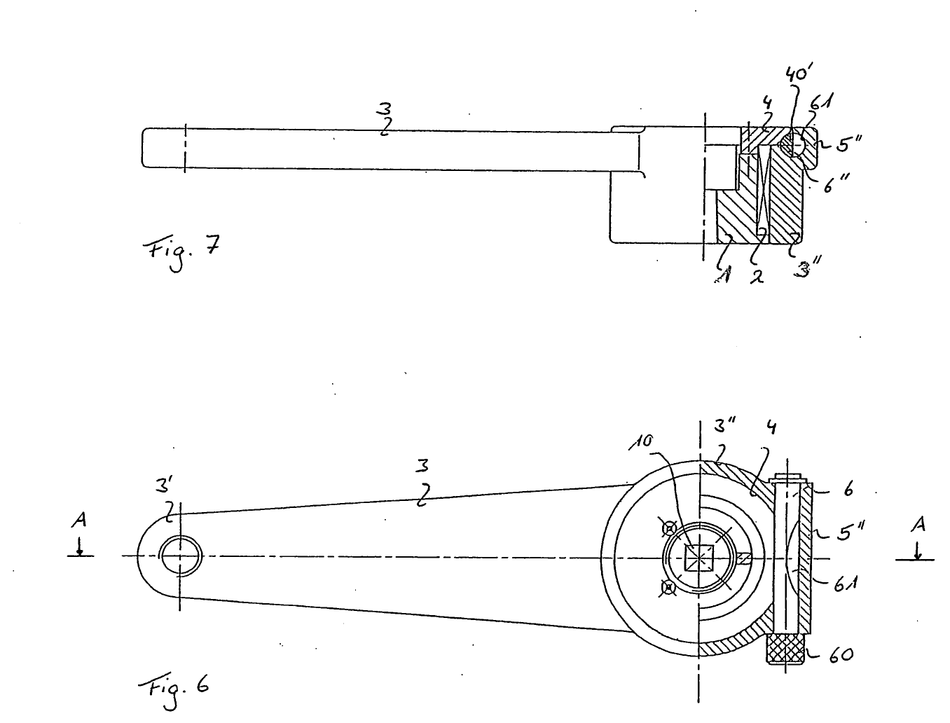

FIGS. 6 and 7 illustrate a third exemplary embodiment. Once again, identical parts are denoted by the same reference numerals and are not described further in the text which follows. As the fixing means there is now a locking pin 6″, which is supported rotatably in a flange 5″ formed on the side of the housing 3″. The flange 5″ can also be arranged on the side of the housing 3″ as a separate element forming part of a retrofitting kit. The locking pin 6″ preferably extends tangentially with respect to the housing 3″ and is situated on a diametrically opposite side of the housing 3″ from one of the pedals. The locking pin 6″ has a turning head 60 which projects beyond the flange 5″ and is used for turning the pin 6″ manually. The pin 6″ has a partially cylindrical lateral recess 61. FIGS. 6 and 7 show a first position, in which the pin 6″ is in engagement with a correspondingly shaped receiving opening 40′ of the cover disc 4 and thus forms a driver for the adapter 1. If the pin 6″ is turned through 180° into a second position, the recess 61 moves into the area of the receiving opening 40′, the cover disc 4 is released and the one-way clutch is activated.

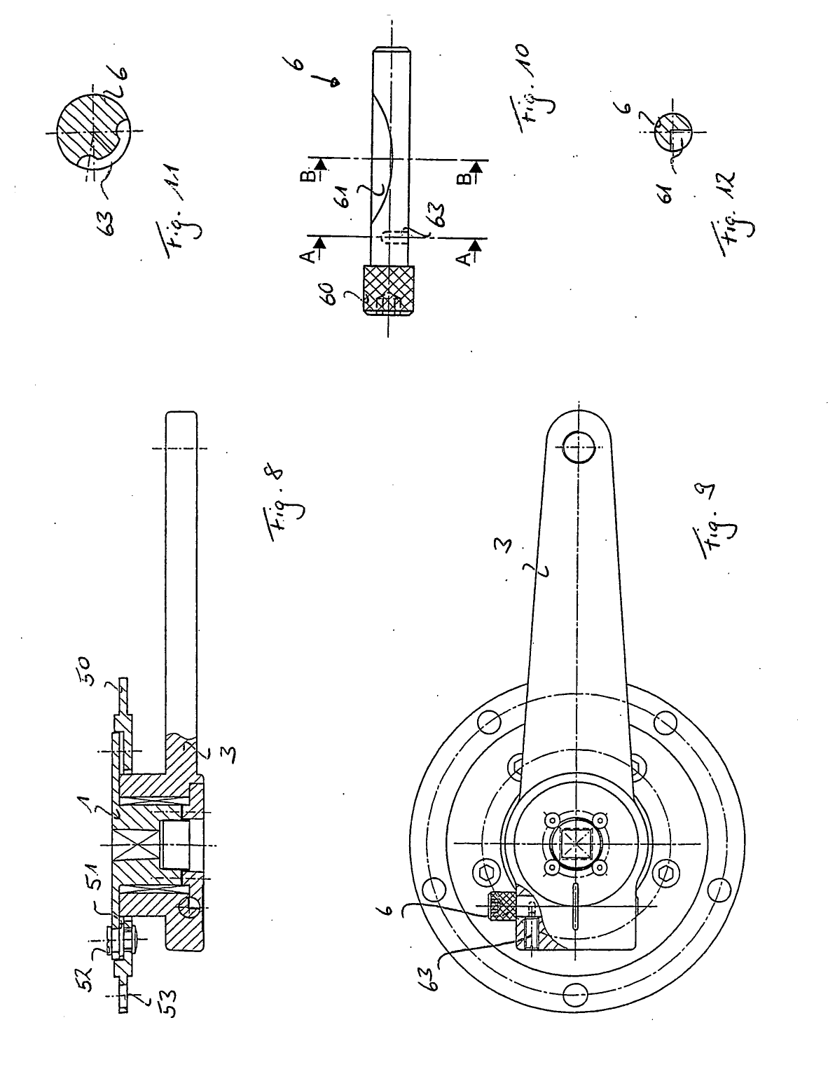

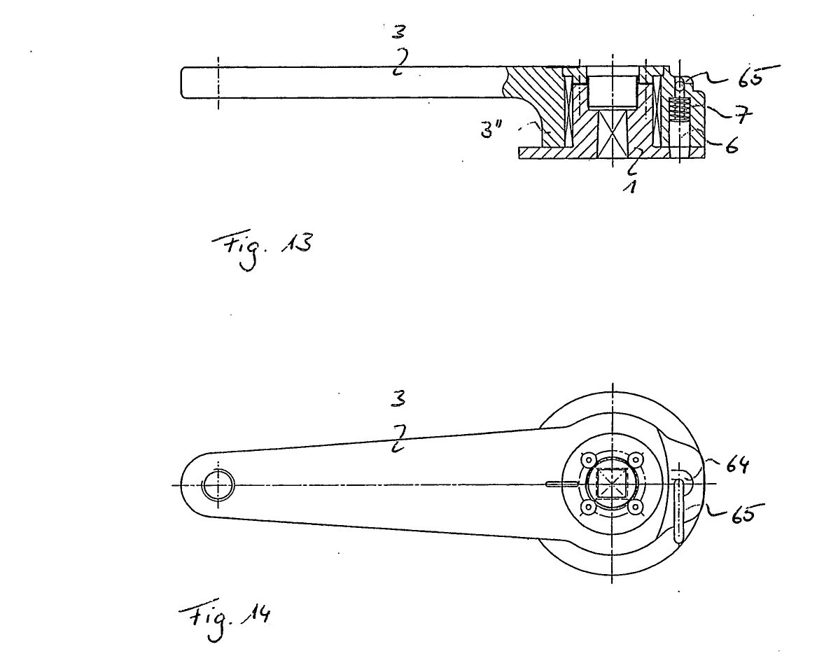

FIGS. 8 to 12 show a fourth exemplary embodiment. It corresponds essentially to the third exemplary embodiment. In this case, however, the locking pin 6 can be fixed. For this purpose, the locking pin 6 has a fixing groove 62, into which a fixing pin 63 can be engaged. The fixing pin 63 is preferably provided with a thread and is screwed into a hole extending transversely to the longitudinal direction of the stud 6.

This exemplary embodiment furthermore illustrates an adapter disc 50, which can be fastened to the adapter or hub 1. A screw, preferably a chain ring screw 52, is preferably used for fastening. A washer 51 can be arranged between the adapter disc 50 and the hub 1. The adapter disc 50 furthermore has a hole 53 for fastening the chain ring (not shown here). The adapter disc can also be fastened turned through 180° or on the other side of the flange of the hub 1. Moreover, the washer 51 can be arranged on different sides. This enables chain rings to be positioned accurately. This adapter disc 50 can also be used with a crank other than the crank according to the invention.

FIGS. 13 and 14 illustrate a fifth exemplary embodiment. In this case, the locking acts on the adapter or the hub 1. In the crank housing 3″ there is a hole that extends parallel to the axis, in which the locking stud 6 is held in a sprung manner. This stud 6 engages in an opening in the flange of the hub 1. The stud 6 can be actuated by means of a two-armed fixing lever 65. If a first arm of this lever 65 is pivoted, it slides down along a sloping guide surface, here referred to as ramp 64, and the second arm, which projects perpendicularly therefrom, strikes the stud 6, pushing the latter into the opening of the hub 1. This example again has the advantage that it is simple to operate. Moreover, the lever 65 ensures a certain fixing of the stud.

The device according to the invention thus allows simple switching between one-way coupling and two-way coupling and extends the available training and therapy options.

### LIST OF REFERENCE NUMERALS

1 Adapter
10 Receptacle for crankshaft
2 Freewheel sleeve
3 Crank arm
3′ Pedal end
3″ Housing
4 Cover disc
40 Receiving opening
40′ Receiving opening
5 Turning ring
5′ Eccentric stud
5″ Flange
50 Adapter flange
51 Washer
52 Chain ring screw
53 Hole
6 Locking stud
6′ Locking wedge
6″ Locking pin
60 Turning head
61 Recess
62 Locking groove
63 Locking pin
64 Ramp
65 Locking lever
7 Return spring
8 Spring strap
9 Stop stud
10′ Rivet

1. Crank with a crank arm (3) and a freewheel element (1, 2), the crank arm (3) having a first end for fastening a pedal and a second end for fastening on a crankshaft by means of the freewheel element (1, 2), a rotation of the crank arm (3) in a first direction transmitting a torque to the crankshaft and, in the case of a rotation of the crank arm (3) in a second, opposite direction, the crank arm (3) rotating in a freewheeling mode, characterized in that the crank has at least one fixing means (6, 6′, 6″) for cancelling freewheeling, allowing the torque of the crank arm (3) to be transmitted to the crankshaft in both directions of rotation.

2. Crank according to claim 1, characterized in that the at least one fixing means (6, 6′, 6″) connects the crank arm (3) and the crankshaft firmly in a direct or indirect manner.

3. Crank according to either of claims 1 and 2, characterized in that the at least one fixing means (6, 6′, 6″) creates a form-locking direct or indirect connection between the crank arm (3) and the crankshaft.

4. Crank according to one of claims 1 to 3, characterized in that the at least one fixing means (6, 6′, 6″) creates a form-locking connection between the second end of the crank arm (3) and an adapter (1) connected in a rotationally fixed manner to the crankshaft.

5. Crank according to one of claims 1 to 4, characterized in that the freewheel element (1, 2) is a freewheel sleeve (2) which forms a one-way clutch with a or the adapter (1) connected in a rotationally fixed manner to the crankshaft, and in that the second end of the crank arm (3) is connected in a rotationally fixed manner to the freewheel sleeve (2).

6. Crank according to one of claims 1 to 5, characterized in that a cover disc (4) is connected directly or indirectly in a rotationally fixed manner to the crankshaft, and in that the at least one fixing means (6, 6′, 6″) engages in a recess of the cover disc (4) when cancelling freewheeling.

7. Crank according to claim 6, characterized in that a plurality of fixing means (6, 6′) is provided, which are arranged in a distributed manner around the periphery of the cover disc (4).

8. Crank according to either of claims 6 and 7, characterized in that there is a turning ring (5) arranged concentrically with the cover disc (4), and in that the at least one fixing means is a sprung locking stud (6) which can be brought into engagement with the cover disc (4) by turning the turning ring (5).

9. Crank according to one of claims 6 to 8, characterized in that the turning ring (5) has arranged on it at least one spring strap (8), which brings the at least one fixing means (6) into engagement with the cover disc (4) when the turning ring (5) is turned.

10. Crank according to either of claims 6 and 7, characterized in that the at least one fixing means is a locking wedge (6′), which is connected to an eccentric stud (5′), and in that the locking wedge (6′) can be brought into engagement with the cover disc (4) by turning the eccentric stud (5′).

11. Crank according to claim 6, characterized in that the at least one fixing means is a locking pin (6″) with a recess (61), the locking pin (6″) being in engagement with the cover disc (4) in a first position, and the recess (61) releasing the cover disc (4) in a second position.
